(19) United States
(12) Patent Application Publication
(10) Pub. No.: US 2002/0156857 A1
(43) Pub. Date: Oct. 24, 2002

(54) Method and system for posting requests for bids for professional services

(75) Inventors: John Mark Brewer, Houston, TX (US); Brandon Kyle Wood, Pearland, TX (US)

Correspondence Address: B. Todd Patterson, MOSER, PATTERSON & SHERIDAN, L.L.P., Suite 1500, 3040 Post Oak Blvd., Houston, TX, 77056, US

(73) Assignee: Provere, Inc.

(21) Appl. No.: 10/127,008

(22) Filed: Apr. 19, 2002

Related U.S. Application Data
(60) Provisional application No. 60/285,357, filed on Apr. 20, 2001.

(51) Int. Cl. G06F 15/16; G06F 17/60

(52) U.S. Cl. 709/206; 705/26

(57) ABSTRACT

A method and system are provided whereby a request for proposals for professional services may be posted on a computer network, e.g., the internet, and professional service providers respond with proposals for their respective services. A user enters a proposal for professional services on a web-site of the computer network. The proposal is received by a first service provider at the site, who responds with a first proposal. The proposal is also received by at least one additional service provider at the site, who responds with a second proposal. The user receives the first and second proposals, and any additional proposals, at the site. The user then evaluates the proposals and selects one of the proposals.

### CROSS-REFERENCE TO RELATED APPLICATIONS

This application claims priority to a pending provisional patent application entitled “Methods and Systems for Electronically Posting Bids and Proposals,” filed on Apr. 20, 2001. That application carries Serial No. Prov. 60/285,357. The provisional application was given Confirmation No. 2617.

### BACKGROUND OF THE INVENTION

1. Field of the Invention

The present invention broadly relates to the field of electronic commerce. More specifically, the present invention relates to a method for requesting bids for professional services using a global computer network. In addition, the invention relates to a method and system whereby providers of professional services, such as attorneys, may submit proposals for their professional services through a computer network in response to a request for bids.

2. Description of the Related Art

Most professions, such as accounting and law, operate under detailed ethical requirements and restrictions. In some instances, the ethical regulations relate to the advertising of professional services. In the case of attorneys, each state has a board of professional responsibility, or some similar branch of the state bar, that administers the advertising regulations. Such rules are considered necessary to ensure trust and confidence of the public in the legal profession, and to ensure that the public is not misled. An attorney who transgresses those rules is subject to the bar's disciplinary system.

It is also noted that many forms of advertising, while permitted, are considered demeaning to the legal profession. For example, in 1985 the Supreme Court issued an opinion permitting an attorney to place a newspaper ad that pictured a defective birth control device, and that invited women who had used it to join in a lawsuit. Such advertising, while permitted (again, under certain requirements and approval from the state bar), are nevertheless considered distasteful by many, both inside and outside of the legal profession. In addition, such advertising may be cost-prohibitive for a small firm or for a new attorney.

At the same time, it cannot be denied that individuals and corporations have legal issues that need to be serviced. Further, it is difficult for these prospective clients to locate counsel who is competent in the field of law, and that is willing to take the case. This is true even when the prospective client enlists the aid of an attorney, and the attorney seeks to refer the case to another firm. Still further, it can be difficult for some clients to locate counsel that is not only competent and willing to perform the work, but is willing to perform the legal services at fees or rates that are affordable for the client.

A system is needed, therefore, whereby potential clients (or an attorney acting for the potential client) can post a need for legal services. Further, there is a need for a system whereby attorneys can review such postings, and respond with proposals for the rendition of legal services. Still further, there is a need for a system that permits attorneys to obtain clients without the necessity of advertising apart from the strictures of a state bar's advertising rules. There is also a need for a system that allows a potential client to receive a variety of proposals in response to a request for legal services, so that the client may select the best proposal based upon a variety of factors, including geographical location of the attorney, experience of the attorney, and cost.

The above scenario outlined for legal services likewise exists in certain other professions. Examples include accounting, marketing, and other professional services. Thus, a need exists in general for a system whereby a request for proposals for professional services may be posted on a global computer network, and professionals may respond with proposals for their respective services.

### SUMMARY OF THE INVENTION

The present invention provides a system whereby a request for proposals for professional services may be posted on a global computer network, e.g., the internet, and professionals may respond with proposals for their respective services. The system first employs a computer network. A user enters a proposal for professional services on a web-site of the global computer network. The proposal is received by a first service provider at the site, who responds with a first proposal. The proposal is also received by at least one additional service provider at the site, who responds with a second proposal. The user receives the first and second proposals, and any additional proposals, at the site. The user then evaluates the proposals and selects one of the proposals.

The user employs several criteria in evaluating proposals. These may include, but are not limited to, geographical location of the service providers, educational and professional experiences of the service providers, and cost. In one aspect, a time limit is imposed upon the service providers to submit proposals. In another aspect, a time limit is imposed upon the user to respond to the proposals.

The present invention thus provides an internet-based exchange for matching prospective clients with professional service providers. In one aspect, the clients are individuals (including businesses) in need of legal services, and the professional service providers are legal professionals such as licensed attorneys.

### BRIEF DESCRIPTION OF THE DRAWINGS

So that the manner in which the above recited features of the present invention are attained and can be understood in detail, a more particular description of the invention, briefly summarized above, may be had by reference to the appended drawings. It is to be noted, however, that the appended drawings are not to be considered limiting of the invention's scope, for the invention may admit to other equally effective embodiments.

FIG. 1 depicts a data processing system as might be used in the proposal requesting system of the present invention.

FIG. 2 is a more detailed, high-level block diagram which further illustrates the major components of the data processing system of FIG. 2.

FIG. 3 is a block diagram of a system for requesting proposals for professional services over a global computer network, according to an embodiment of the present invention. The system includes a server.

FIG. 4 is an enlarged block diagram of the server of FIG. 3.

FIG. 5 is a flowchart outlining the steps to be taken by a user of the system for requesting proposals for professional services over a computer network.

FIG. 6 is a flowchart outlining the steps to be taken by a legal service provider for responding to requests for proposals for professional services over a computer network.

FIGS. 7A and 7B present exemplary text from a URL as might be used to aid service providers in selecting a pricing model.

### DETAILED DESCRIPTION OF THE PREFERRED EMBODIMENT

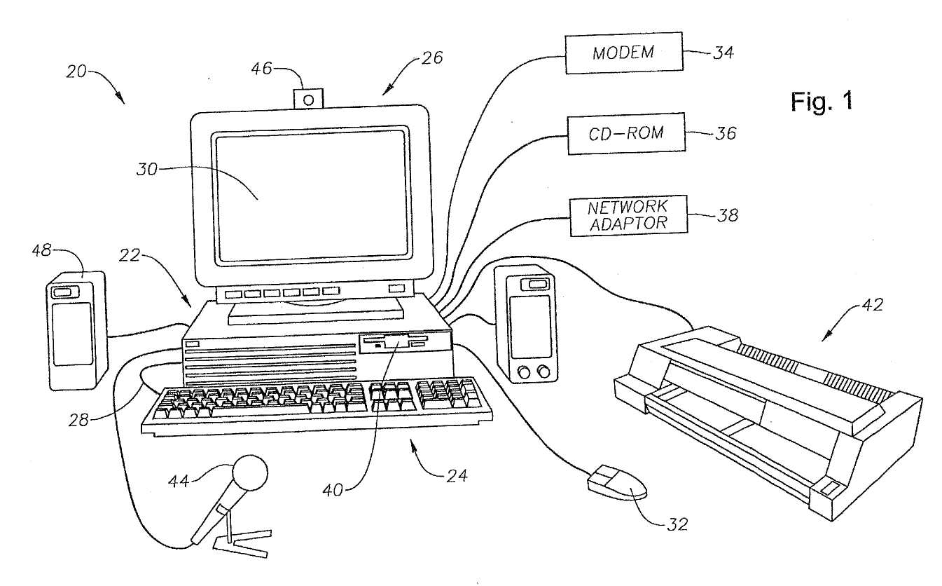

FIG. 1 depicts a data processing system 20 as might be used in the system 300 of the present invention. The data processing system 20 is capable of executing the computer program which enables a user 200 to request proposals for professional services over a global computer network. According to the system 300, a request for professional services may be posted on the internet, and professional service providers may respond with proposals for their respective services.

The data processing system 20 can be the data processing system from which a user can submit requests for proposals from professional service providers; or it can function as a server for the network. Generally, when functioning as a server, the data processing system 20 will have more processing power, storage capability, and memory than when it is functioning as a user's data processing system.

The data processing system 20 may be implemented utilizing any general purpose computer or so-called personal computer. Various features within a data processing system 20 are known. Typical features include a processor 22, a keyboard 24, and a display 26. The keyboard 24 is coupled to the processor 22 by a cable 28. The display 26 includes a display screen 30, which may be implemented utilizing a cathode ray tube (CRT), a liquid crystal display (LCD), an electroluminescent panel, or the like. The data processing system 20 also includes a pointing device 32, which may be implemented utilizing a track ball, joystick, touch sensitive tablet or screen, trackpad, or as illustrated in FIG. 1, a mouse 32. The pointing device 32 may be utilized to move a pointer or cursor on the display screen 30.

The processor 22 may also be coupled to one or more peripheral devices, such as a modem 34, a CD-ROM 36, a network adaptor 38 and floppy disk drive 40, each of which may be internal or external to the enclosure of the processor 22. An output device such as a printer 42 may also be coupled to the processor 22. Speakers 48, camera 46, and microphone 44 are optionally provided for multimedia applications.

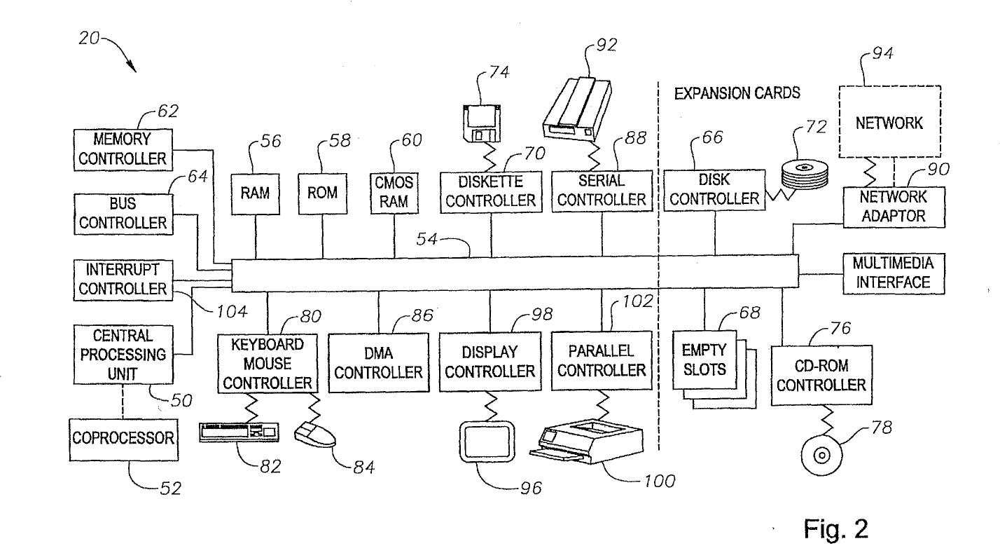

With reference now to FIG. 2, there is depicted a high-level block diagram which further illustrates the major components that may be included in the data processing system 20 of FIG. 1. The data processing system 20 is controlled primarily by computer readable instructions, preferably in the form of software. Such software may be executed within a central processing unit (CPU) 50 to cause the data processing system 20 to do work. In many known workstations and personal computers, the central processing unit 50 is implemented by a single-chip CPU called a microprocessor. Examples of such microprocessors include the microprocessor sold under the trademark “PENTIUM” by Intel Corporation and the microprocessor sold under the trademark “PowerPC” by International Business Machines Corporation.

FIG. 2 includes a coprocessor 52. The coprocessor 52 is an optional processor, distinct from the main CPU 50. The coprocessor 52 performs additional functions or assists the main CPU 50. Recently, the functions of many coprocessors have been incorporated into more powerful single-chip microprocessors.

The CPU 50 fetches, decodes, and executes instructions, and transfers information to and from other resources via the computer's main data-transfer path. The main data transfer path is presented in FIG. 2 as the system bus 54. Such a system bus connects the components in the data processing system 20 and defines the medium for data exchange. The system bus 54 typically includes data lines for sending data, address lines for sending addresses, and control lines for sending interrupts and for operating the system bus 54. An example of such a system bus 54 is the PCI (Peripheral Component Interconnect) bus. Some of today's advanced busses provide a function called bus arbitration that regulates access to the bus by extension cards, controllers, and the CPU 50. Devices that attach to these busses and arbitrate to take over the bus are called bus masters.

Memory devices are coupled to the system bus 54. The memory devices include a random access memory (RAM) 56, a read only memory (ROM) 58, and a nonvolatile memory 60. Such memories include circuitry that allows information to be stored and retrieved. The ROMs 56 contain stored data that cannot be modified. Data stored in RAM 58 can be read or changed by the CPU 50 or other hardware devices. Nonvolatile memory is memory that does not lose data when power is removed from it. Nonvolatile memories include ROM, EPROM, flash memory, bubble memory, or battery-backed CMOS RAM. As shown in FIG. 2, a battery-backed CMOS RAM may be utilized to store system configuration information.

Access to RAM 56, ROM 58, and nonvolatile memory 60 may be controlled by a memory controller 62 and a bus controller 64. The memory controller 62 may provide an address translation function that translates virtual addresses into physical addresses as instructions are executed. The memory controller 62 may also provide a memory protection function that isolates processes within the system and isolates system processes from user processes. Thus, a program running in user mode can access only memory mapped by its own process virtual address space; it cannot access memory within another process's virtual address space unless memory sharing between the processes has been set up.

An expansion card or expansion board is a circuit board that includes chips and other electronic components connected in a circuit that adds functions or resources to the computer. Typical expansion cards add memory, disk-drive controllers 66, video support, parallel and serial ports, and internal modems. For laptop, palmtop, and other portable computers, expansion cards usually take the form of PC Cards, which are credit card-size devices designed to plug into a slot in the side or back of a computer. An example of such a slot is the PCMCIA slot (Personal Computer Memory Card International Association) which defines type 1, 11 and III card slots. Thus, empty slots 68 in the data processor 20 may be used to receive various types of expansion cards or PCMCIA cards.

Disk and diskette controllers are also included in the data processing system 20 of FIG. 1. The disk controller 66 and the diskette controller 70 each include special-purpose integrated circuits and associated circuitry that direct and control reading from and writing to a hard disk drive 72 and a floppy disk or diskette 74, respectively. Such disk controllers 66, 70 handle tasks such as positioning read/write head, mediating between the drive and the microprocessor, and controlling the transfer of information to and from memory. A single disk controller may be able to control more than one disk drive.

CD-ROM controller 76 may be included in data processing system 20 for reading data from the CD-ROM 78 (compact disk read-only memory). Such CD-ROMs use laser optics rather than magnetic means for reading data. A multi-media interface 108 interfaces with multi-media end devices such as the speakers 48, the camera 46, and the microphone 44. These multi-media end devices provide the ability to engage in video conferencing and other applications which require video and sound input and output.

A keyboard mouse controller 80 is provided in the data processing system 20. The keyboard mouse controller 80 allows for interfacing between a keyboard 82 and a pointing device, such as mouse 84. Such pointing devices 84 are typically utilized to control an on-screen element, such as a cursor, which may take the form of an arrow having a hot spot that specifies the location of the pointer when the user presses a mouse button. Other pointing devices include the graphics tablet, the stylus, the light pen, the joystick, the puck, the trackball, and the trackpad.

A direct memory access (DMA) controller 86 is also shown with the data processing system 20. A direct memory access (DMA) controller 86 may be used to provide a memory access that does not involve the CPU 50. Such memory accesses are typically employed for data transfer directly between memory and an “intelligent” peripheral device, such as between memory 56 and disk controller 66.

Communication between the data processing system 20 and other data processing systems may be facilitated by a serial controller 88 and a network adaptor 90. Both the serial controller 88 and the network adaptor 90 are coupled to the system bus 54. The serial controller 88 is utilized to transmit information between computers, or between a computer and peripheral devices, one bit at a time over a single line. Serial communications can be synchronous (controlled by some time standard such as a clock) or asynchronous (managed by the exchange of control signals that govern the flow of information). Examples of serial communications standards include the RS-232 interface and the RS-422 interface.

As illustrated, such a serial interface may be utilized to communicate with a modem 92. A modem 92 is a communications device that enables a computer to transmit information over a standard telephone line. Modems 92 convert digital computer signals to analog signals suitable for communication over telephone lines. More recently, modems are able to communicate through high-speed digital lines. The modem 92 may provide a connection to other sources of software, such as a server, an electronic bulletin board, and the Internet or World Wide Web.

A network adaptor 90 may optionally be used to connect the data processing system 20 to a local area network 94. The network 94 may provide grouped computer users with a means of communicating and transferring software and information electronically. Additionally, the network 94 may provide distributed processing, which involves several computers and the sharing of workloads or cooperative efforts in performing a task.

The display 96 is controlled by a display controller 98. The display 96 is used to display visual output generated by the data processing system 20. Such visual output may include text, graphics, animated graphics, and video. As noted, the display 96 may be implemented with a CRT-based video display, an LCD-based flat-panel display, or a gas plasma-based flat-panel display. The display controller 98 includes electronic components required to generate a video signal that is sent to the display 96.

A printer 42 is also shown in FIG. 2. The printer 42 may be coupled to the data processing system 20 via a parallel controller 43. The printer 42 is used to put text or a computer-generated image on paper or on another medium, such as a transparency. Other types of printers may include an imagesetter, a plotter, or a film recorder. The parallel controller 43 is used to send multiple data and control bits simultaneously over wires connected between the system bus 54 and another parallel communication device, such as the printer 42.

Additional information concerning operation of a data processing system may be found in unrelated U.S. Pat. No. 6,014,643. The '643 patent was issued to Minton in 2000. Columns 3-7 of that patent are incorporated herein by reference.

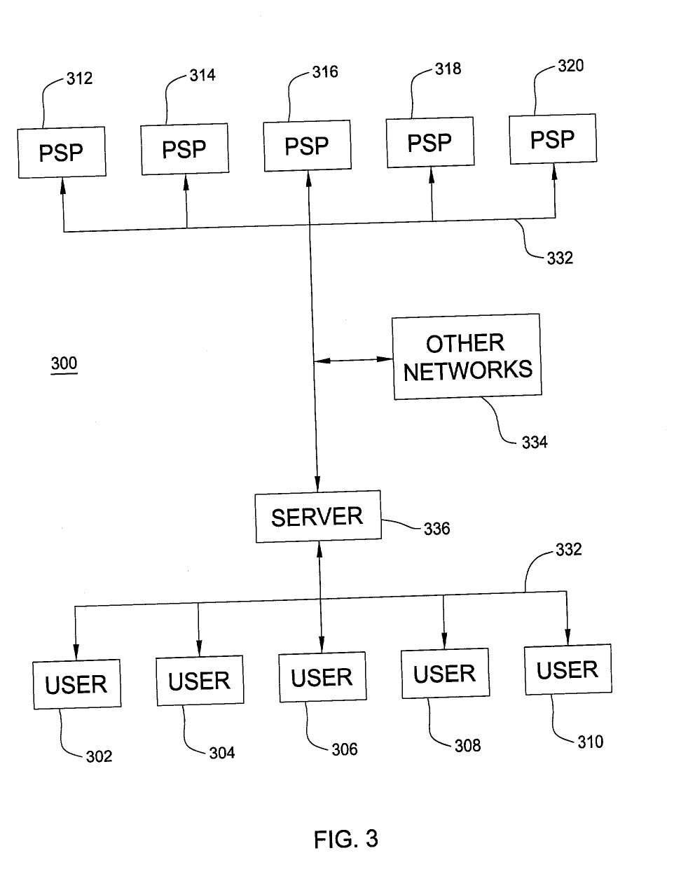

Referring now to FIG. 3, FIG. 3 is a schematic diagram of a system 300 for requesting proposals for professional services over a computer network, e.g., the internet, according to an embodiment of the present invention. According to the system 300, a request for professional services may be posted on the internet. Requests are submitted by a plurality of users, depicted by blocks 302, 304, 306, 308 and 310, that are connected to a central server 336. Professional service providers (PSP's) 312, 314, 316, 318 and 320 respond with proposals for their respective services through a web-site administered on the server 336.

In the systems of the present invention, the users 302-310 are prospective clients operating on data processing systems, such as the data processing system 20 depicted in FIGS. 1 and 2. For purposes of the present inventions, the terms “user” and “clients” include both individuals and business entities, including but not limited to persons, sole proprietorships, partnerships and corporations of various types. In addition, the interchangeable terms “users” and “clients” include both principals and professionals (such as attorneys) acting on behalf of the principals. The PSP's are also operating on data processing systems, such as the data processing system 20 depicted in FIGS. 1 and 2. For purposes of the present inventions, the term “professional service provider” includes any professional service provider, including but not limited to architects, accountants, engineers and attorneys.

In the exemplary diagram of FIG. 3, the system 300 is being used by users 302-310 to post (submit) requests for proposals for legal services on a web-platform, i.e., a web-site, using that platform's interface. Each of the users 302-310 is a prospective client who is submitting a request for proposals for legal services. The blocks for the users 302-310 represent prospective clients operating on data processing systems, such as the data processing system 20 depicted in FIGS. 1 and 2. Each of the PSP's 312-320, in turn, is receiving and reviewing the respective requests of the users 302-310. Each of the PSP's 312-320 may be an attorney, or a representative or agent of an attorney. The blocks for the PSP's 312-320 represent legal professionals operating on data processing systems, such as the data processing system 20 depicted in FIGS. 1 and 2.

The various users 302-310 and the various PSP's 312-320 are connected to a server 336. Connection is by communications links 332. In the preferred embodiment, the communications links 332 represent modem-to-modem communications links between the users 302-310 and the server 336, and between the PSP's 312-320 and the server 316. Although the users 302-310 and the PSP's 312-320 may communicate with the server 336 using a modem to send information over public telephone lines, many other types of communications links are possible. Some other examples of possible communication methods with the server 336 are cable modems, local area networks, wireless communications, fiber optics lines, ISDN lines and others. The method by which the users 302-310 and the PSP's 312-320 communicate with the server 336 is not important, as the present invention simply requires that the users 302-310 and the PSP's 312-320 be able to send and receive information to the server 336. Also, although only five users 302-310 and only five PSP's 312-320 are shown in FIG. 3, the present invention can accommodate many additional users 302-310 and PSP's 312-320 at any given time.

It is noted that FIG. 3 depicts the server 336 schematically as a single unit. However, in reality, the server 336 is comprised of several computing units, and these units may be distributed over a large area. The server 336 would typically contain external storage units, communication interfaces for transferring data to users, processor and memory subsystems, and other computing devices (not shown) that are commonly attached to server devices.

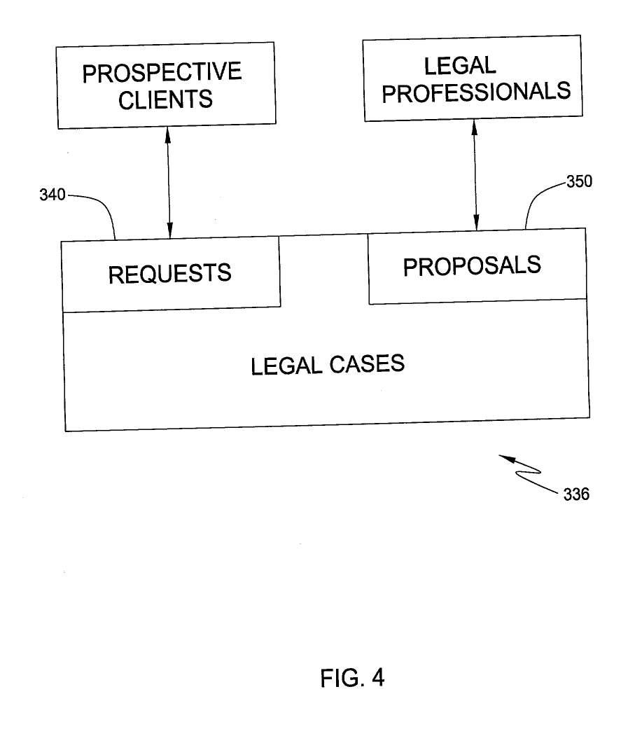

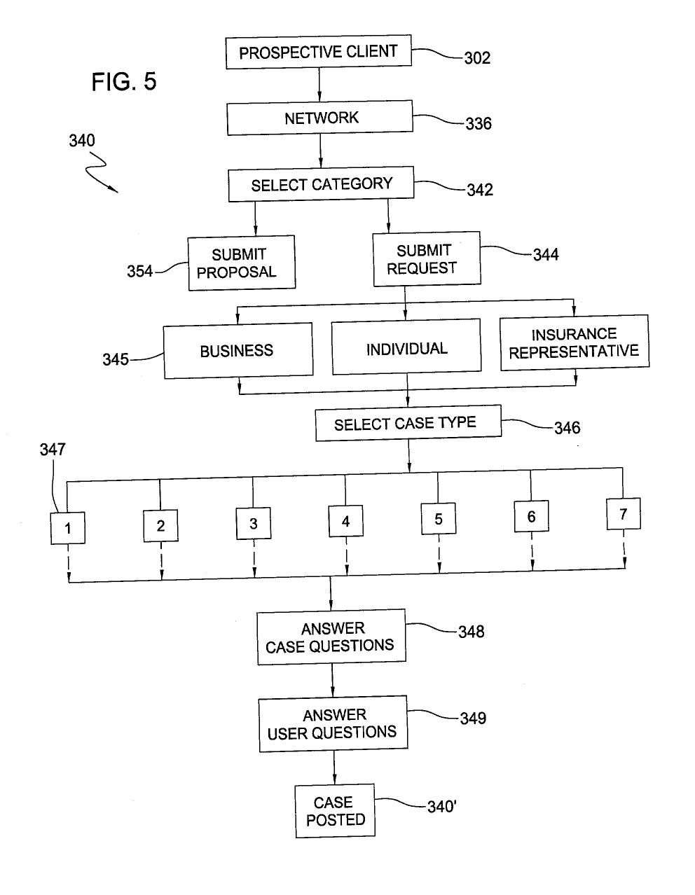

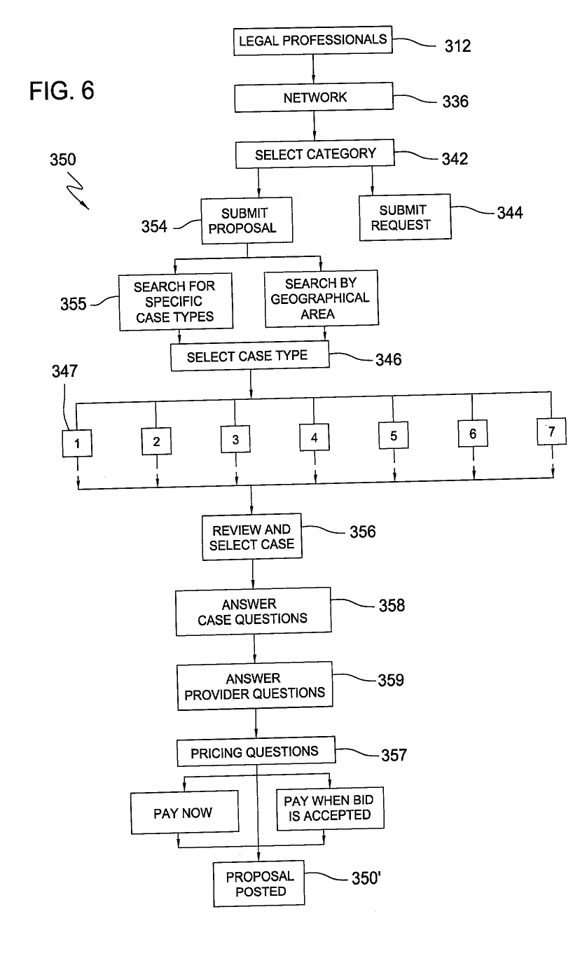

FIG. 4 presents an enlarged view of the server 336 shown in FIG. 3. In this diagram, it can be seen that prospective clients (shown as users 302-310 in FIG. 3) submit requests for proposals for legal services to the server 336. Requests are posted 340′ using the provided interface. The posting process is shown as 340, and is discussed in greater detail in connection with FIG. 5. Legal professionals (shown as PSP's 312-320 in FIG. 3), in turn, submit proposals 350′ for legal services to the server 336. The term “legal professionals” includes, but is not limited to, attorneys, paralegals, investigators, legal secretaries, and any agent of an attorney. The proposals 350′ are submitted in response to the requests 340′ . The legal professionals 312-320 submit their bids, i.e., proposals 350′, on the same web-platform, using a unique interface provided by that platform. Like prospective clients 302-310, legal professionals may submit bids using the provided interface. The proposal process is shown as 350, and is discussed in greater detail in connection with FIG. 6.

In operation of the system 300, a user 302 enters a proposal (shown at 340′ in FIG. 5) for legal (or other professional) services on a web-site of the computer network 336. The proposal is received by a first attorney 312 (or other PSP or PSP representative) at his or her data processing system 20. The attorney 312 then responds with a first proposal (shown at 350′ in FIG. 6). The user's proposal is also received by at least one additional attorney 314, who responds with a second proposal. The user 302 receives the first and second proposals, and any additional proposals, through the network 336. The user 302 then evaluates the proposals and selects one of the proposals as a “winning bid.” Thus, the system 300 provides an internet web-based platform to deliver a bid-based system for connecting users with service providers in the delivery of any price-based service or product, as well as any combination of services and products.

FIG. 5 is a flowchart outlining the steps 340 to be taken by a user 302 of the system for posting a request for proposals 340′ for professional services 300 over a computer network. The user 302, such as a prospective client of legal services, first enters the web-site. Upon accessing the web-site via the network 336, the user 302 is asked to select a category 342. The user 302 is directed to select either the posting area of the site 344, or the bidding area of the site 354. In one aspect, the user is presented with a screen having a first option 354 that says “I am a lawyer,” or a second option 344 that says “I need a lawyer.” The user 302 selects the posting area of the site 344, so as to submit requests for proposals for legal services.

Upon entering the posting area of the site 344, the prospective client 302 is given various options 345 pertaining to the nature of the prospective client. For example, the prospective client 302 may be asked to select between: business; individual; insurance representative; or intellectual property. In this example, the “business” option would later (at block 346) direct a prospective client 302 that is a business to request proposals on cases that relate to businesses. Similarly, individuals would later be directed to request proposals on legal matters that pertain to individuals, e.g., personal injury, bankruptcy, employment; family law, wills, and criminal matters. It is understood that the manner in which the categories 345 are specifically labeled is not important; what is important is that the system 300 categorize the cases in a manner that assists responding legal professionals 312 in identifying cases on which to submit proposals.

Following the category selection 345, the user 302 is taken to an area of the site which allows him/her to select a more specific case type 346. Multiple case types 346 exist. For example, a prospective client 302 that has identified itself as a “business” category would be given a list of case types 347 such as (1) Bankruptcy (Reorganization and Liquidation—Chapter 7 & 11); (2) Construction Arbitration & Litigation; (3) Litigation (Defense: I/We have been sued); (3) Litigation (Plaintiff: I/We want to sue); (4) Mergers & Acquisitions; and Real Estate. These are shown schematically in blocks (1)-(7) as part of categories 347. Any number or types of categories 347 may be listed. Again, the specific label used is not important, so long as it assists prospective clients and attorneys in becoming matched. After selecting a case category 347 from pre-defined answer choices, such as from “pull down” menus, the prospective client 302 is asked a series of questions. In one aspect of the invention 300, there are as few as eight and as many as 24 case-specific questions 348, depending upon the type of case 347. Each question 348 has a finite number of answer choices (of less than ten choices), or open entry fields with specific character limitations. These restricted answer choices and character limitations are employed to prevent submissions outside of the system profile.

After answering the case-specific questions 348, the user 302 is then asked to “continue.” A warning in red font is preferably given to the user 302 at this point. For example, the warning could state:

IMPORTANT:

If you continue, you will be submitting a request for bid in accordance with all the terms and conditions of the use agreement. Please make sure that you have fully read, understand and agree to those terms and conditions before you click the ‘continue’ button.

By clicking the ‘continue’ button, you expressly warrant and represent to the system administrator and to the bidders who review and/or bid on your case (attorneys), that you are the person stated in your request, that the answers are true and correct and that YOU ARE SUBMITTING YOUR REQUEST IN GOOD FAITH AND BECAUSE YOU GENUINELY AND LEGITIMATELY DESIRE TO EMPLOY AN ATTORNEY. You further understand and agree that bidding attorneys will be submitting their bid(s) to you in good faith and in reliance on your answers, and further, that they will bind themselves to their bid and will be bound to pay a fee for the privilege of bidding on your case. You should not, therefore, submit any information which is false, fraudulent, bogus or misleading as you will create economic harm and damage to the attorneys who will pay money to bid on your case. Therefore, PLEASE CAREFULLY CHECK YOUR ANSWERS TO THE CASE AND GENERAL LEGAL QUESTIONS, AND INSURE THAT YOU HAVE ANSWERED THEM CAREFULLY AND TRUTHFULLY. IT IS FRAUDULENT AND UNLAWFUL TO SUBMIT A REQUEST FOR BID UNDER FALSE PRETENSES; THE SUBMISSION OF FALSE OR FRAUDULENT INFORMATION MAY SUBJECT YOU TO CIVIL PENALTIES, CRIMINAL PROSECUTION OR BOTH.

After being presented with this warning, the prospective client 302 is permitted to answer a series of general questions 349. The general questions are not case-specific, but apply to any user 302. These questions 349 preferably have pre-defined answer sets (“pull down” menus). In this way, finite answer choices are again given, including a question requiring the selection of a desired price structure or open ended proposals. In one aspect, up to ten general user questions 349, are asked. In one aspect, answering the general user questions 349 serves to create an individual account that is established and maintained by the system administrator. This individualized data is linked to the answers provided by the user 302 in the previous screens and is made available to the service provider upon acceptance of a proposal 350′ by the user 302.

After answering the general user questions 349, the posting process 340, is completed. The foregoing answer choices 348, 349 selected by the user 302 are electronically submitted to the various service providers 312-320 for their review and consideration in formulating their proposals 350′, if any. The criteria for determining the inclusion of questions and answers is that they fit within a database construct which provides bidders 312-320 with a minimum amount of information necessary to formulate a price-based bid 350′. The request 340′ is then posted.

It is noted that, in the preferred arrangement for the system 300, the users 302-310 are not charged for the opportunity to submit requests 340′ for proposals. This encourages the submission of requests 340′, thereby generating interest and activity in the system 300. As discussed below, the system administrator preferably is compensated through a pricing model 357 elected by the service providers 312-320 during a proposal process 350′.

In one arrangement of the system 300, a prospective client 302 may select between two options re: bids. One option allows the client 302 to “Get a New Bid;” the other option allows the prospective client 302 to “Check on a Bid.” The “Check on a Bid” option (not shown in FIG. 5) allows a prospective client 302 to access the system 300 in such a way that allows him/her to view responsive proposals 350′ from attorneys 312-320. In one aspect of the system 300, the general questions 349 will include a selected “Sign-In Name” and a selected “Password.” Prospective clients 302-310 are required to enter their respective names and passwords to access this information. This is a “Logging In” process.

Referring now to FIG. 6, FIG. 6 is a flowchart outlining the steps 350 to be taken by a legal service provider 312 of the system for submitting proposals 350′ for professional services 300. The legal service provider 312 first enters the web-site. Upon accessing the web-site via the network 336, the legal service provider 312 is asked to select a category 342. The legal service provider 312 is required to select either the posting area of the site 344, or the bidding area of the site 354. The legal service provider 312 selects the bidding area of the site 354, so as to submit a proposal 350′ for legal services.

Upon entering the bidding area of the site 354, the legal service provider 312 is given two options 355 from which to select: browse postings by type; or browse postings by geographical area. Following that selection 355, the legal service provider 312 is then taken to an area of the site which lists the postings organized by either category or geography. At this point the legal service provider 312 is allowed to browse all requests (postings) in the selected category or geographical area 355.

If the attorney 312 elects to browse requests 340′ by category, he or she is taken to a page like page 345 of FIG. 5. This means that attorney 312 is given various options 345 pertaining to the nature of the prospective client. For example, the attorney 312 may be asked to select between: business; individual; insurance representative; or intellectual property. Again, it is understood that the manner in which the categories 345 are specifically labeled is not important; what is important is that the system 300 categorize the cases in a manner that assists responding legal professionals 312 in identifying cases on which to submit proposals 350′.

After selecting a case type 346, the attorney 312 is presented with the various requests-for-proposals 340′ that correspond to the case type 346. The page of the web-site will look similar to page 347 discussed above, in that multiple categories are provided. The various requests-for-proposals 340′ are linked with the more specific case types 347.

Each request 340′ has a link permitting the service provider 312 to view more information about the case 340′. Thereafter, the attorney (or other PSP) 312 may select a case 340′ for bidding. A screen 356 is provided on the web-site to permit the legal service provider 312 to select and bid on a case 340′. The bid screen 356 provides the service provider 312 with a series of case specific questions 358, followed by provider questions 359. Each of these questions 358, 359 preferably includes pre-defined answer choices (“pull down” menus) or severely limited open data input fields (such as for dollar amounts). The criteria for determining the inclusion of questions and answers in the bid area 350 is that they fit within the same database construct applicable to users, and they provide objective, industry-recognizable qualification data, and user-specific information.

In one arrangement of the system 300, the attorney 312 is required to sign in to the system 300 as a registered bidder 312 before he or she can respond with a proposal 350′. In one aspect, the general questions 359 will include a selected “Sign-In Name” and a selected “Password.”

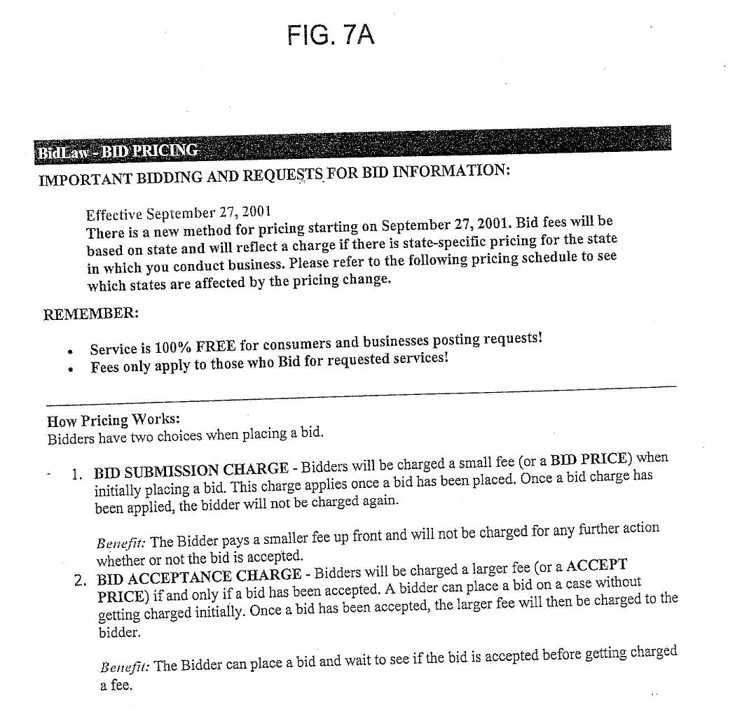

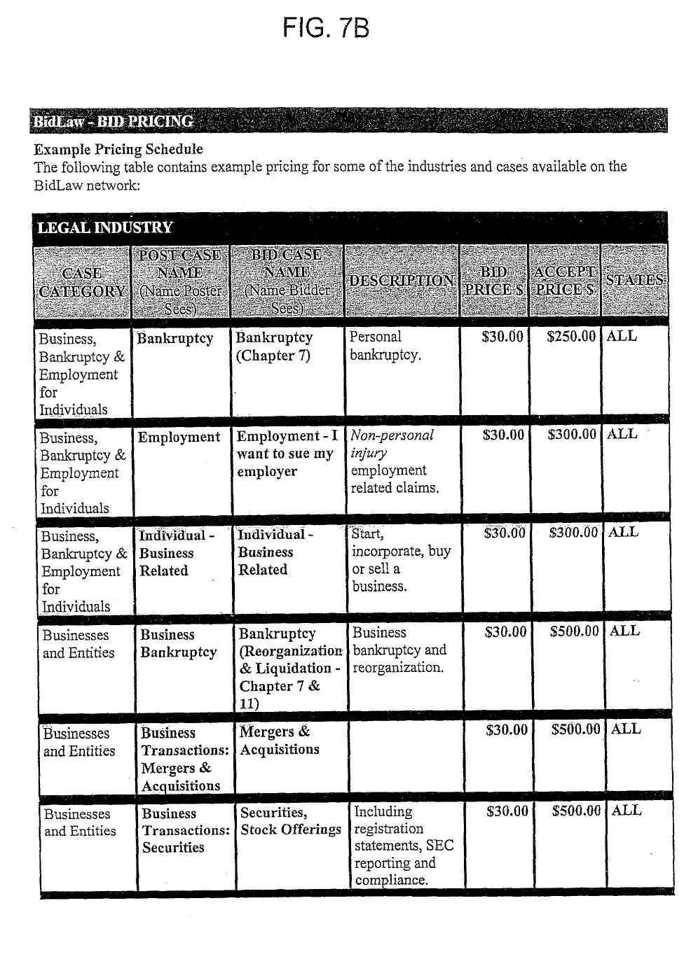

After answering the questions 358, 359, the service provider 312 is asked questions 357 concerning the preferred pricing model. This step 357 allows the service provider 312 to select a pricing model for payment to the system 300. In one aspect, the pricing model 357 allows the service provider to either pay a small fee, e.g., $30.00, to the system (or a system administrator) at the time the proposal 350′ is submitted, or pay a larger “contingent” fee, e.g., $250.00, payable upon acceptance of the bid 350′ by the user 302. Under the second option, no payment is due if the proposal is not accepted. The choice of a contingent fee to the bidder 312 is integral to the system 300. In this respect, a dedicated screen may be provided for the pricing model selection. FIGS. 7A and 7B present exemplary text from a URL as might be used to aid the service provider 312 in selecting a pricing model 357.

Upon choosing the pricing model 357, the bidding process 350 is complete. The service provider's bid 350′ is electronically posted, but without the personal identifying data of the service provider 312. Certain answer choices provided by the service provider 312 are matched with certain identical questions answered by the posting user 302. The user 302 is provided with the answers to all these questions, and is additionally provided with a percentile match with respect to the questions which are asked of both the posting user 302 and the bidding service provider 312. Included within this information is the proposed cost (or fee) of services, professional experience of the professional service provider 312, and geographical location of the professional service provider 312. Other more specific criteria may be utilized for matching such as desired years of industry experience for the PSP or size of the PSP's firm or organization.

Upon acceptance of a proposal 350′ by the posting user 302, the user 302 is provided with the bidder's personal identifying data. The service provider 312 is likewise provided the personal identifying data of the user 302 who posted the request 340′ for a proposal 350′.

It should be noted that in the system 300, the identity of a user 302 is not provided to a responding service provider 312 until after a proposal 350′ has been accepted. In this respect, the data provided to the PSP's 312-320 is truncated. Likewise, the identity of a provider 312 is not provided to the posting user 302 until after a proposal 350′ has been accepted. After a proposal 350′ has been accepted, an electronic message (“e-mail”) may be sent to the winning service provider 312. The personal identifying data of the user 302 and the provider 312 is released to the counterparts 312, 302 after a proposal 350′ has been accepted. The transaction is then complete.

It is also noted that the server 336 may interface with other computing resources or networks. These include news services and hyperlinks to legal-related web pages. Such resources are depicted in block 334 of FIG. 3. These other networks 334 may be administered by entities other than the one which administers the system 300 for requesting proposals for professional services. It is noted that the success of the system 300 depends on obtaining a regular flow of requests 340′ for proposals 350′ or propels from users 302-310 in service and product industry groupings. To aid in generating business, the system 300 provides an interface to link existing web-platforms (web-sites) of product and service providers in each industry grouping to the web-platform (web-site). Thus, for example, a user of a service provider's web-site can initiate a request for a proposal 350′ on the web-platform 300, without it appearing that she has ever “left” the service provider's 312 web-platform The system's 300 web-platform then processes the request 340′ like any other, but through database filtering, submits the request 340′ to the service provider 312 which provided the user 302 with the link or interface 334. This method of obtaining users 302 is referred to as an “Affiliate Program.”

The interface which the system 300 provides through its Affiliate Program to link industry web-platforms (web-sites) to the system's web-platform (web-site) consists of these components: (1) providing an interface within an industry web-site; (2) permitting customization of the system 300 web-platform from pre-defined sets of criteria available on an automated basis from the system 300 web-platform; (3) allowing users of that industry web-site (i.e., requesters or bids or proposals) to submit a request for bid; and (4) limiting the publication of that request for bid to the industry service/product provider that employed the interface. As an example, an existing law firm web site can provide its users of that web-site with an interface linkage to a customized view of the system's 300 web-platform. The user 302 can then submit a request for bid to that law firm, within the system 300. This “Affiliate Program” part of the business system thereby provides users from relevant industry groups.

The system is also designed to maintain as confidential the information provided by the respective users 302-310. This is particularly important where legal or accounting services are sought. Thus, the system 300 utilizes database driven questions, each with a preset choice of answers. These answers provide a data set which is sufficient to enable a legal need to be described so as to permit a monetary bid, but without revealing information which is confidential or privileged under the law. This methodology is equally applicable to non-legal industry groups. The methodology serves four functions which are critical to the overall business system: (1) preventing users from disclosing more information about themselves or their “case” than is necessary for a bid; (2) preventing disclosure of personal or sensitive information; (3) preventing the inadvertent disclosure of information which otherwise would be subject to protection from further disclosure under applicable state and federal law regarding privileged information; and (4) preventing users from learning each other's identities.

An optional feature of the system 300 is a rating system. On completion of the transaction (which the successful bid underlies), each user may rate the other party to the transaction from the web-based platform. Immediately after a rating is submitted, it is posted with any other ratings of that party on the web-based platform. The cumulative ratings of all parties are posted for unobstructed viewing by other users.

Using the foregoing, closed-architecture, question specific method, persons needing legal services, as well as any other defined industry services are connected with a lawyer or other industry service provider—by way of the internet. Provere operates on a blind bid basis—allowing requesters to anonymously post requests to bidders who cannot view other bids, and thus creating a more neutral and fair bidding process. Neither the bidder (lawyer) nor the person requesting a bid (user or client) are required to join anything; nor are they required to subscribe to Provere. Anyone can be a user; any qualified service provider (lawyer) can bid.

While the foregoing is directed to embodiments of the present invention, other and further embodiments of the invention may be devised without departing from the basic scope thereof, and the scope thereof is determined by the claims that follow. For example, the PSP could be a professional other than a lawyer, and the user could be seeking professional services other than legal services. In addition, the PSP could actually be an employer (or a representative of an employer, including a recruiter), and the users could be individuals seeking employment. In this arrangement, the matching relates to the years of experience of the user, size of the company, the geographical location of the company, and so forth. The professional services would actually be employment.

1. A method for soliciting proposals for professional services over a computer network, comprising the steps of:
posting a request-for-proposal from a user, the request-for-proposal being posted on a web-platform of the computer network;
receiving, at the web-platform, a first bid for professional services from a first professional service provider in response to the request-for-proposal, enabling the user to evaluate the first bid;
receiving, at the web-platform, at least one additional bid from a corresponding at least one additional professional service provider in response to the user's request-for-proposal, enabling the user to evaluate the at least one additional bid;
receiving a selection by the user of the first bid from the first professional service provider; and
notifying the first professional service provider of the acceptance of the first bid, and of the identity of the user.

2. The method for soliciting proposals of claim 1, further comprising the step of notifying the user of the identity of the first professional service provider.

3. The method for soliciting proposals of claim 1, further comprising the step of providing the first and the at least one additional professional service providers with a pricing model for submitting their respective proposals for legal professionals.

4. The method for soliciting proposals of claim 3, wherein the pricing model permits the professional service providers to either pay a first amount at the time the respective proposals are submitted, or a second amount at the time the respective proposals are accepted by a user, the second amount being larger than the first amount.

5. The method for soliciting proposals of claim 1, wherein the professional service providers are legal professionals.

6. The method for soliciting proposals of claim 1, wherein the user is a legal professional acting on behalf of a prospective client.

7. The method for soliciting proposals of claim 2, wherein the user's selection is based upon various criteria including cost of services, professional experience of the professional service providers, and geographical location of the professional service providers.

8. The method for soliciting proposals of claim 4, wherein:
the professional service provider is an employer seeking employees;
the professional services define employment; and
the user is a prospective employee seeking employment.

9. A system for conducting a business activity between at least one user and a professional service provider over a computer network, the system comprising a server, wherein the server:
receives information from the user that can be viewed by professional service providers, and posts that information as a request for a proposal for professional services,
receives information from the professional service providers, and allows the professional service providers to submit respective proposals in response to the request for a proposal from the user;
provides the professional service providers with a pricing model for submitting their respective proposals for legal professionals; and
permits the user to accept a selected proposal from one of the professional service providers.

10. The method for soliciting proposals of claim 9, wherein the pricing model permits the professional service providers to either pay a first amount at the time the respective proposals are submitted, or a second amount at the time the respective proposals are accepted by a user, the second amount being larger than the first amount.

11. The system for conducting a business activity of claim 10, wherein the professional service providers are legal professionals.

12. The system for conducting a business activity of claim 11, wherein the user is a legal professional on behalf of a prospective client.

13. The system for conducting a business activity of claim 9, wherein:
the information received from the professional service providers comprises information concerning the geographical location of the professional service provider, the professional experience of the professional service provider, and the proposed cost for services; and
the user selects a proposal for professional services based upon the information received from the professional service provider.

14. The system for conducting a business activity of claim 13, wherein the server further matches information received from the user with information received from the professional service providers.

15. The system for conducting a business activity of claim 14, wherein the server further provides a percentile match with respect to the information received from both the posting user and the responding service provider.

16. The system for conducting a business activity of claim 13, wherein the server:
notifies the professional service provider that provided the selected proposal of the acceptance of the proposal, and of the identity of the user; and
notifies the user of the identity of the professional service provider that provided the selected proposal.

17. The system for conducting a business activity of claim 13, wherein the user accesses the computer network through a link provided by a web-platform of a professional service provider.

18. The system for conducting a business activity of claim 17, wherein the professional service provider providing the link is the only professional service provider that sees the request of the user.

19. The method for soliciting proposals of claim 13, wherein:
the professional service providers are employers seeking employees;
the professional services define employment; and
the user is a prospective employee seeking employment.

20. A business method for matching professional service providers with clients seeking professional services, comprising:
receiving, from a client, a proposal identifying desired professional services on a web site;
posting a truncated version of the proposal so that the truncated proposal can be viewed by professional service providers;
receiving, on the web site, from at least one professional service provider, a bid for professional services corresponding to the truncated proposal;
providing the at least one professional service provider with a pricing model for submitting the respective bids for legal professionals, the pricing model permitting the professional service providers to either pay a first amount at the time the respective bids are submitted, or a second amount at the time any respective bid is accepted by a client, the second amount being larger than the first amount.;
posting the bids for the client to review;
permitting the client to select a bid from the at least one professional service provider; and
sending identification information representative of a selected professional service provider to the client, and sending identification information representative of the client to the selected professional service provider.
